(19) United States
(12) Patent Application Publication
(10) Pub. No.: US 2018/0361775 A1
(43) Pub. Date: Dec. 20, 2018

(54) Book binding device and applicator

(71) Applicant: Paul Gokkel, Utrecht (NL)

(72) Inventor: Paul Gokkel, Utrecht (NL)

(21) Appl. No.: 15/736,831

(22) PCT Filed: Jun. 16, 2016
(86) PCT No.: PCT/NL2016/050429

§ 371 Date: Dec. 15, 2017

(30) Foreign Application Priority Data
Jun. 16, 2015 (NL) 2014971

(51) Int. Cl. B42C 19/02; B42B 5/00; B26D 1/00; B26F 1/22; B31F 5/02

(52) U.S. Cl. CPC B42C 19/02; B42B 5/00; B26D 1/0006; B26D 2001/006; B31F 5/027; B31F 5/022; B26F 1/22

(57) ABSTRACT

The present invention relates to a book binding device to perform a binding process comprising a coupling process in which two stacks of sheets, such as sheets or, paper, each with at least one sheet, are coupled to each other by tabs in the sheets, and a cutting process to produce the tabs along a respective tab edge of at least one of the two stacks to be coupled, to bind the sheets into a book along a spine side of the sheets, the device comprising: —two stack holders to each hold a stack of at least one sheet, —a cutting assembly to perform the process of cutting out sheet material to form the tabs, —a coupling assembly to couple the tabs of two respective stacks to produce the book, in which —the stack holders serve as positioners for the two stacks to keep the stacks properly oriented during the binding process at all times.

The present invention relates to a book binding device to perform a binding process comprising a coupling process in which two stacks of sheets, such as sheets of paper, each with at least one sheet, are connected to each other by tabs in the sheets and a cutting process to produce the tabs along a respective tab edge of at least one of the two stacks to be coupled, to bind the sheets into a book along a spine side of the sheets. The present invention also relates to an applicator.

The present inventor has also invented a binding system based on tabs on one edge of paper sheets such that two or more stacks of sheets are coupled to each other into a book by the tabs. These tabs are part of the sheet and are formed by cutting out intervening material along the edges of the sheets to be bound.

A book that is obtained by using such sheets provides a number of advantages. Such advantages include environmental advantages because only the paper is needed, advantages in processing to the usability or readability of the content of the book because once opened, the book easily lies open. The sheets remain lying open relatively flat. A reason for this is that the sheets fold easily along the edges and that the tabs facilitate turning pages.

The practical production of such a book requires some handwork because the tabs and especially the sidepieces of the tabs need to be hooked into each other to form the book. There is also the question of the moment at which the tabs should be created: before or after printing information on the sheets.

To simplify the production of such a book, the present invention provides a single-book binding device to perform a binding process comprising a coupling process in which two stacks of sheets, such as paper sheets, each with at least one sheet, are connected to each other by tabs in the sheets, and a cutting process to produce the tabs along a respective tab edge of at least one of the two stacks to be coupled, to bind the sheets into a book along its spine, the device consisting of:
two stack holders to each hold a stack of at least one sheet,
a cutting assembly to perform the process of cutting out sheet material to form the tabs,
a coupling assembly to couple the tabs of two respective stacks to produce the book, in which
the stack holders serve as positioners for the two stacks to keep the stacks properly oriented during the binding process at all times.

An advantage of such a book binding device is that by performing this process by the book binding device, the tabs are formed and the coupling is done. For example, no handwork is required for this other than placing the stacks in the respective stack holders. The user can therefore provide the sheets with the information and then have the book binding device make the book; and as a further advantage, automatically.

In a first preferred embodiment according to the present invention, the cutting assembly comprises a shaft to which a number of cutting elements can be attached with an outline shape that is suitable for cutting during a rotational movement of the shaft, such as with a shape of a ring segment or cylinder segment. This creates a cutting-out assembly that can be constructed economically. A further advantage of such a cutting-out assembly is that it can easily be integrated into the machine together with the coupling assembly.

To drive the assemblies, a further preferred embodiment provides drive means such as a motor or a crank to drive the cutting-out assembly.

Such drive means are by further preference connected to the coupling assembly, such as by a transmission, such as by a gear rack construction, by further preference with a cog arranged on the shaft of the cutting assembly. This creates a construction that when a drive is applied, such as the motor, both the cutting-out assembly and the coupling assembly can be driven. The necessary space is created simply by adjusting the length of a gear rack once the design principle has been understood.

In a further preferred embodiment, at least one of the stack holders in the book binding device is arranged to be moved along the tab edge of the stack to transfer the respective stack between a cutting-out position and a coupling position, by preference along a movement stroke of essentially a half tab length or essentially a whole tab length. In this way, the single binding process performs both the cutting-out process to create the correct tabs in the correct position and the coupling process to couple the tabs of both stacks while these stacks are properly positioned relative to each other.

By further preference, at least one, and preferably each, end of the punch shaft has a cog such that each cog meshes with a separate gear rack on both the underside and the top side, and the bottom gear racks and the top gear racks are each connected to their own respective push arm. This embodiment also contributes to the advantage of being able to perform both the coupling process and the cutting process with a drive.

By further preference, the punch blades in the book binding device are clamped to the shaft in a number of different vertical positions to punch in steps to reduce the force during punching. This makes it possible to build the construction lighter, or makes it more durable.

By further preference, cutting elements of the punch are formed by bent, sharp V-shaped protrusions made of a thin strip of hard material, for example hardened steel, such that the cutting elements comprise a transverse section. By further preference, this strip of hard material is cast into a plastic or light metal shaft, where this shaft is rotated during punching and therefore the cutting elements pierce through the material to be punched.

To provide construction and production advantages, the device has by further preference a number of cartridges linked in series, which each comprise a separate cutting element embedded in a plastic or metal shaft section and the cutting plate corresponding with this embedded into a plastic or metal holder, such that the holders of the cutting plates can be coupled to each other robustly and the shaft sections of the cutting elements can be fastened to each other robustly into a shared punch shaft, preferably by means of mortise joints between the shaft sections to prevent twisting of the punch shaft.

By further preference, the punch blades on the shaft successively punch the sheets of material on both stack holders in the bottom position of the two stack holders, and in the top position of both stack holders elongated protrusions on both push arms couple the tabs of the punched sheets to each other to bind the two stacks of sheet material that are held in the stack holders.

By further preference, both stack holders can be moved some distance outward and thus be fixed in different positions, such that in each position of the stack holders, the sheets of material in the stack holders can be punched again by the punch mechanism and by this repeated punching of the sheets of material, lips with higher flanges are formed to couple thicker stacks of material.

By further preference, the punch shaft and/or the push arms and/or the stack holders that slide outward can be rotated or shifted into the different positions by one or more electric drives that can be controlled by a programmable electronic controller.

By further preference, it comprises an applicator for the automatic application of a cover around the spine of a book, which is designed as a cartridge with a roll of covers temporarily linked to each other by means of perforation or tear lines, and for each punch and coupling cycle positions a new cover by means of an electric drive under the stack of sheets to be bound from the paper tray.

A further aspect of the invention relates to an applicator for the automatic application of a cover around the spine of a book, with the characteristic that this cartridge with a roll of covers temporarily connected to each other by means of perforation or tear lines, where each cover has a rectangular exterior, such that one or more creases parallel to the long side of the rectangular exterior, are applied and both long edges of the rectangular exterior include a glue strip or double-sided tape, with a coupling strip in between, optionally tabbed, that is fastened to the middle part of the rectangle such that with the double folding of the rectangular exterior of the cover, around a crease under the connection strip, the part of the coupling strip with the tabs in it, or out of which the tabs need to be punched by the punch device, protrude freely.

An applicator according to a further embodiment for the automatic application of a cover around the spine of a book, with the characteristic that the roll, on both sides of the middle strip of covers coupled to each other, has two guide strips or bands, with optional sprocket perforation holes, such that the guide strips or bands are wound around a counter spindle for more accurate feed of the covers.

Further advantages, characteristics and details of the present invention will be described below in greater detail based on one or more preferred embodiments with reference to the appended figures. Similar but not necessarily identical components from different preferred embodiments are indicated with the same reference numbers.

This invention will be explained in more detail based on the example embodiments of it in the following figures:

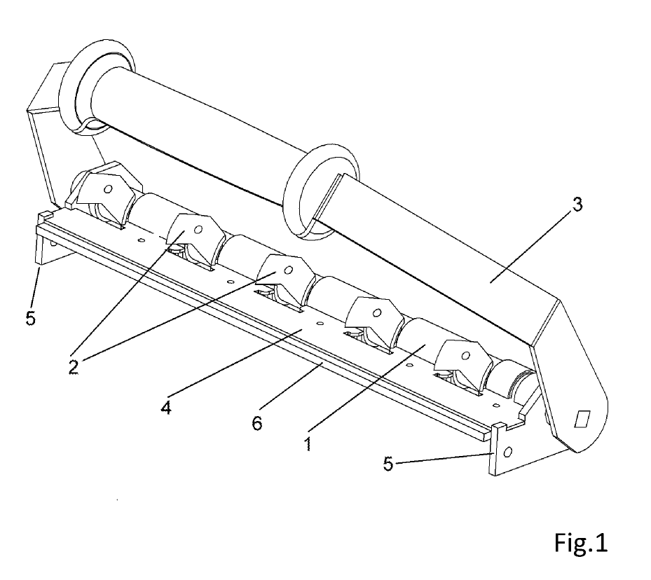

FIG. 1 is a perspective view of a part of a preferred embodiment.

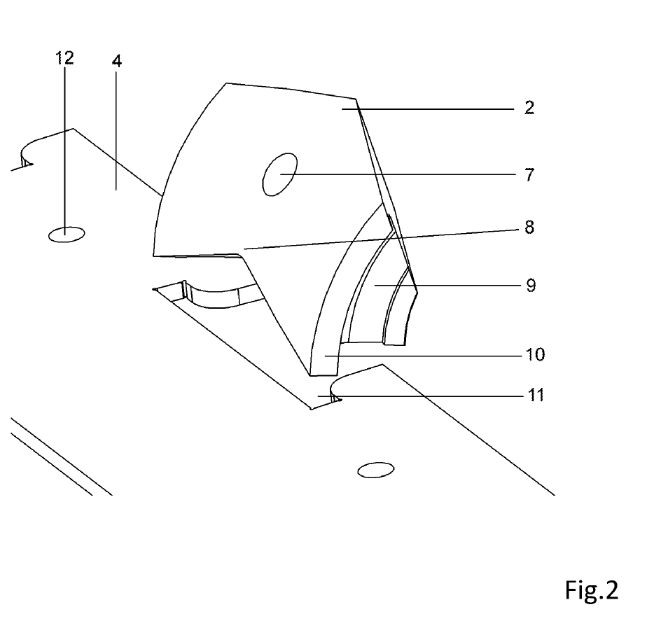

FIG. 2 is a perspective view of a detail of FIG. 1.

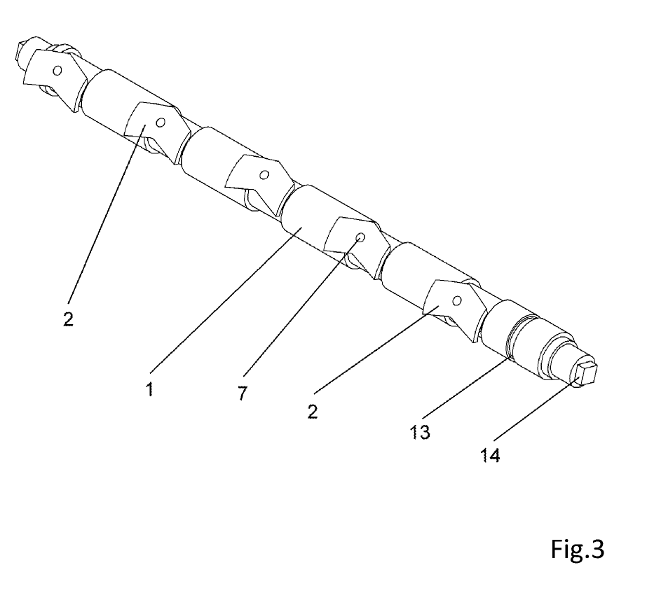

FIG. 3 is a perspective view of a further detail of FIG. 1.

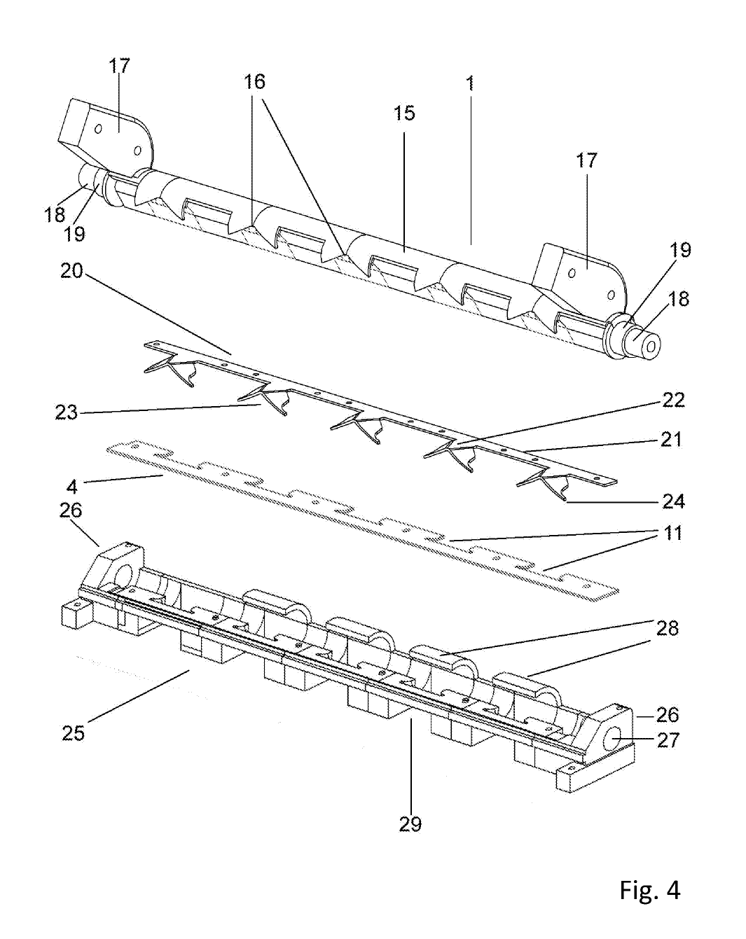

FIG. 4 is four perspective views of a detail of a preferred embodiment.

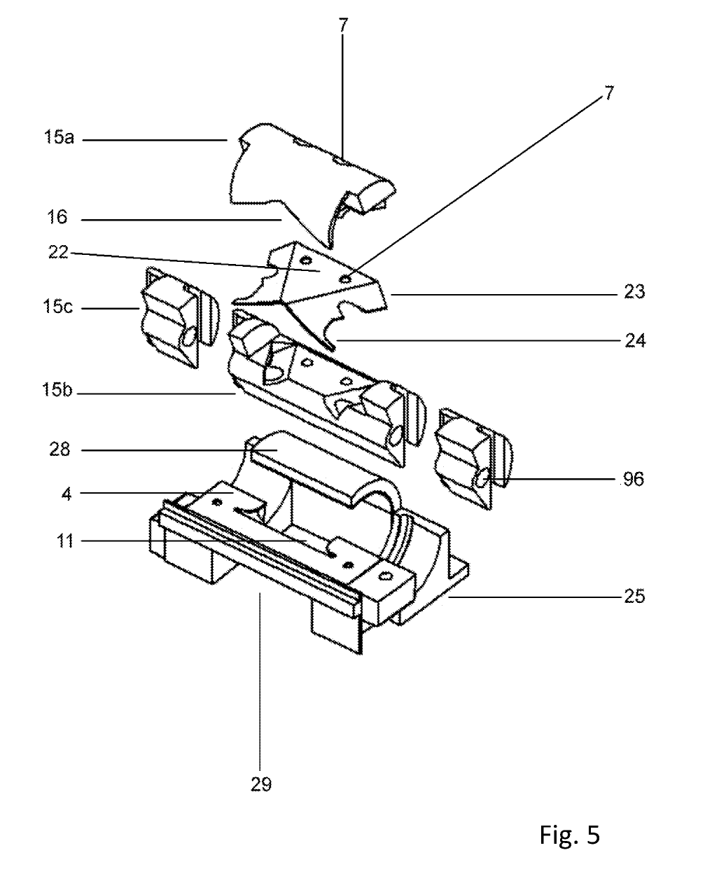

FIG. 5 is a detail of FIG. 4.

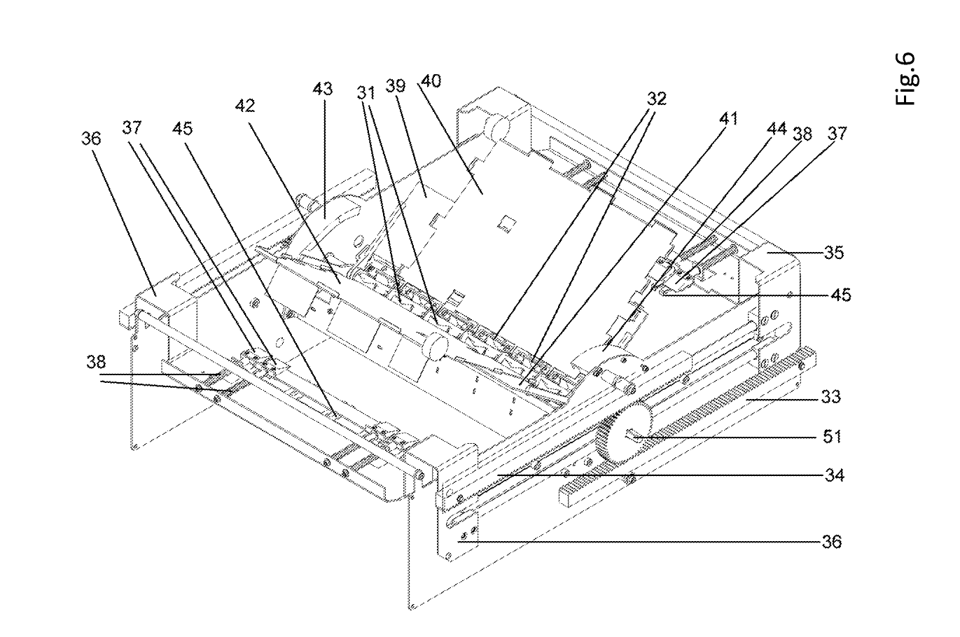

FIG. 6 is a perspective view of a preferred embodiment according to the present invention.

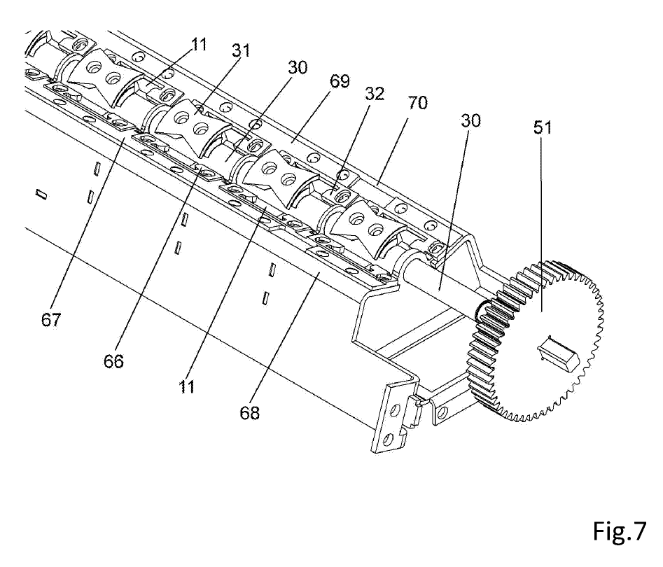

FIG. 7 is a perspective view of a detail of this preferred embodiment.

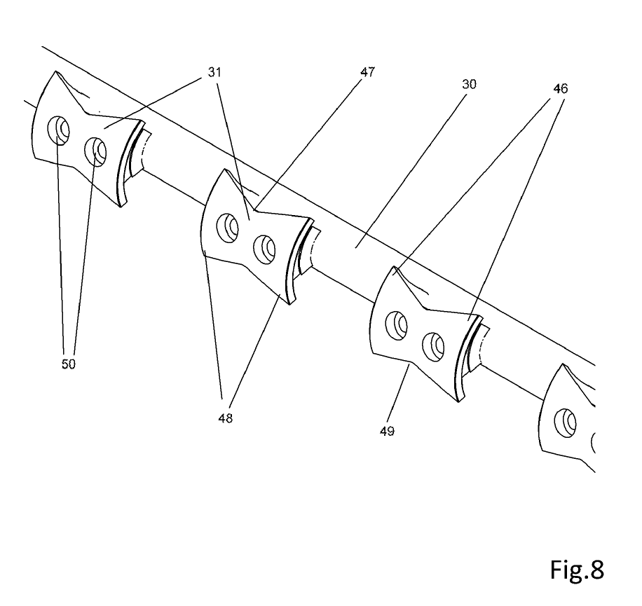

FIG. 8 is a perspective view of a further detail.

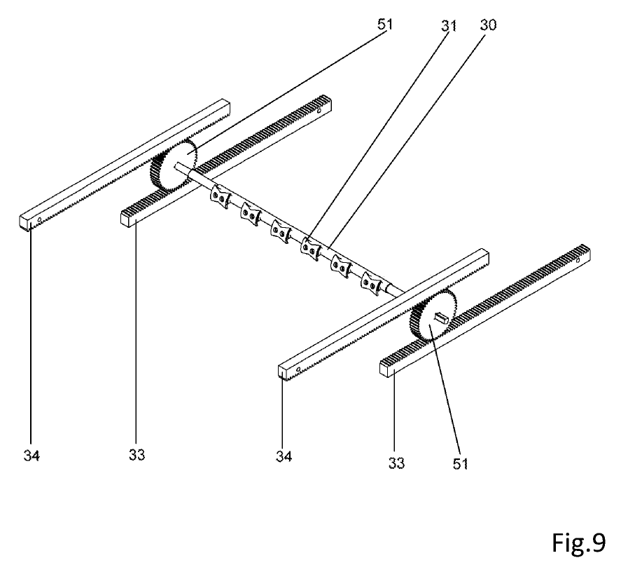

FIG. 9 is a perspective view of a further detail.

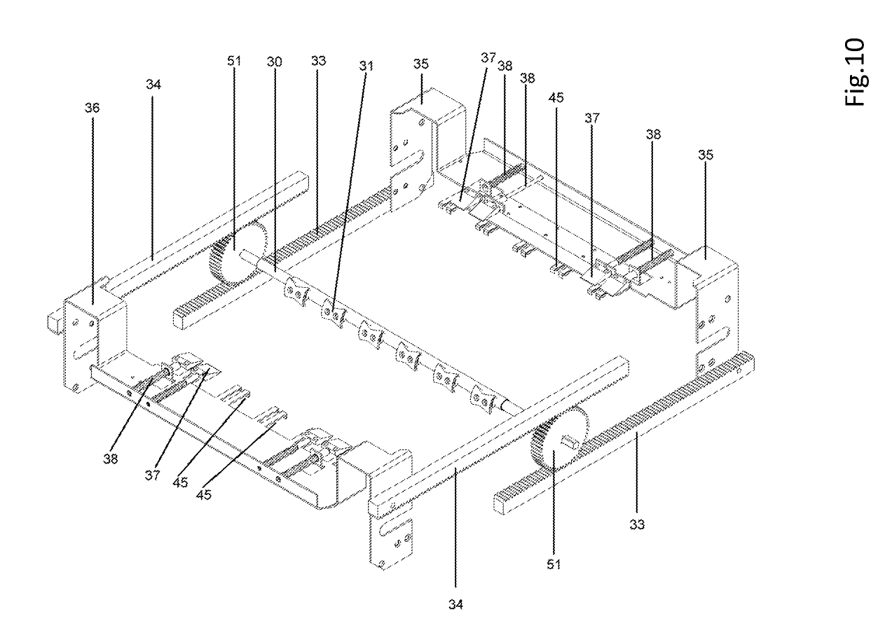

FIG. 10 is a perspective view of a part of their further detail.

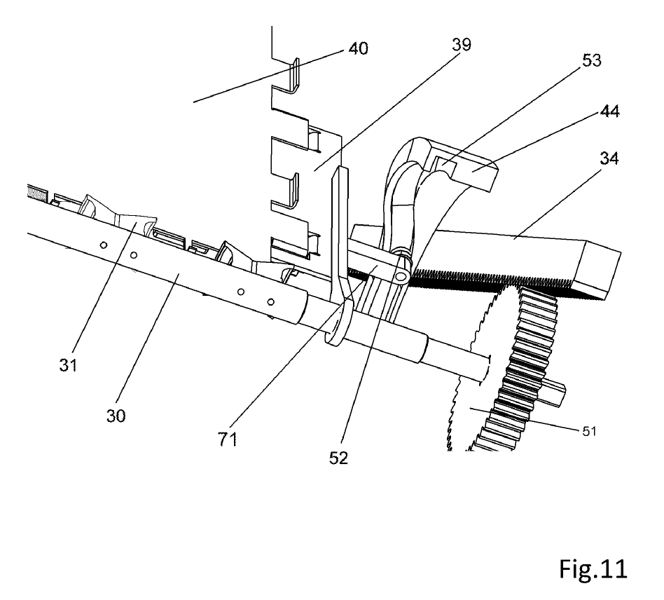

FIG. 11 is a further perspective view of a further detail.

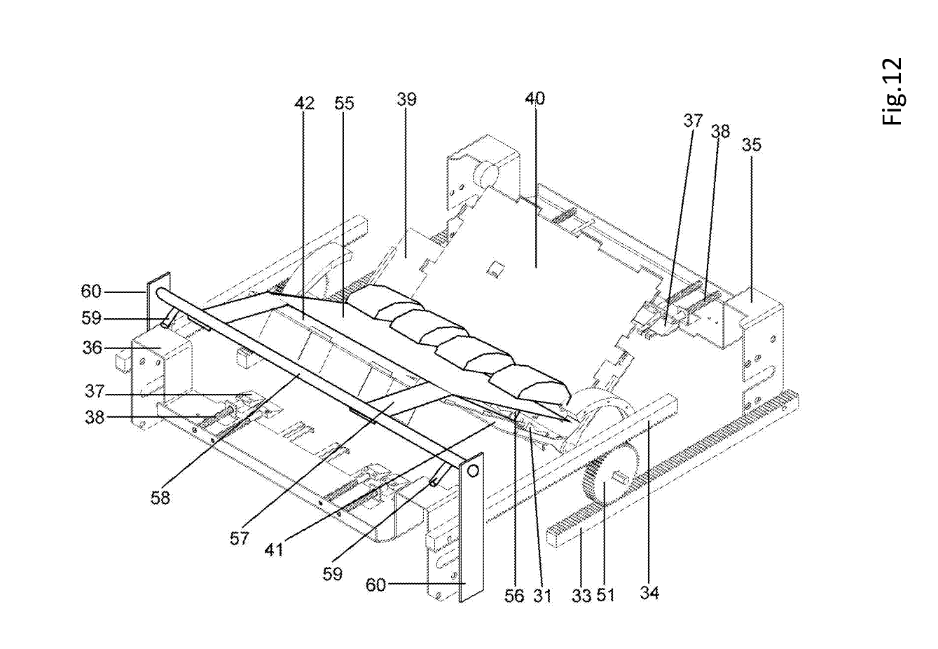

FIG. 12 is a further perspective view of a further detail.

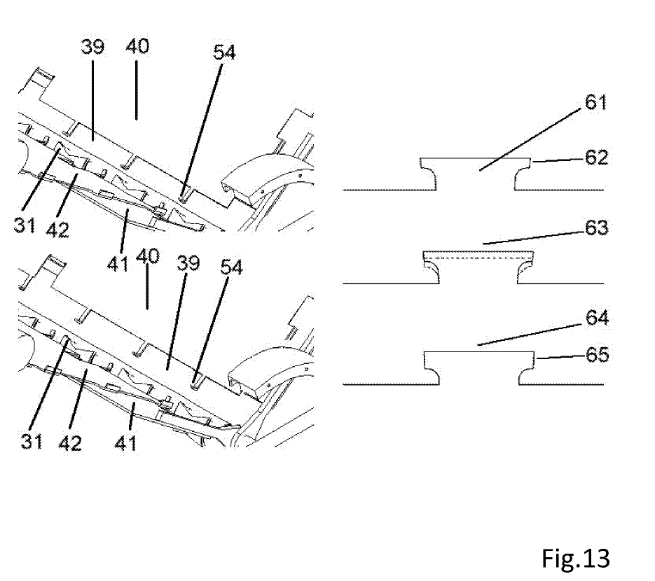

FIG. 13 is a schematic view of a further detail.

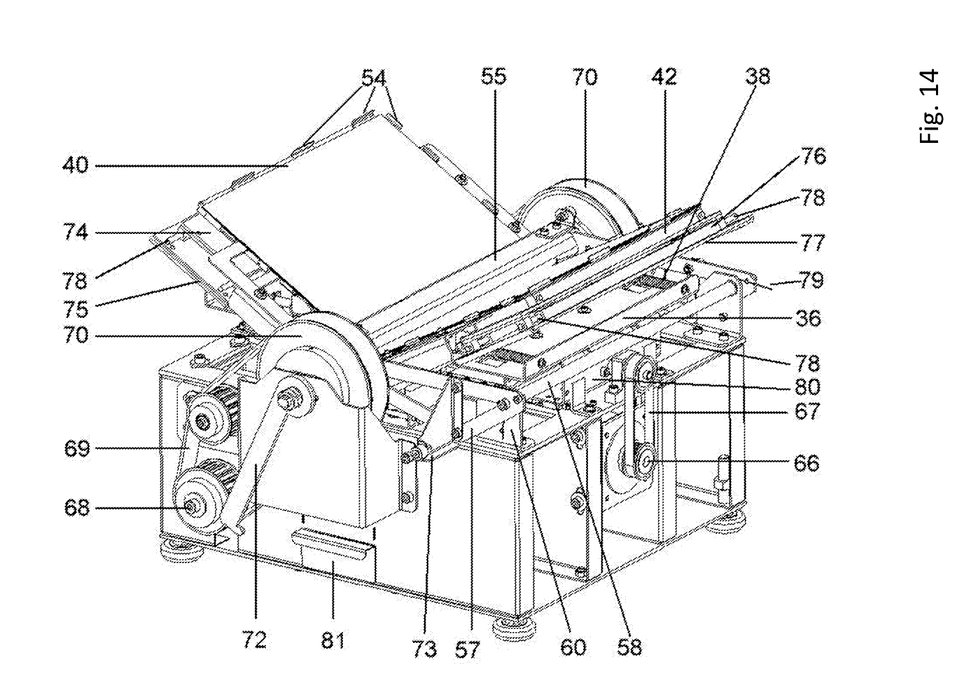

FIG. 14 is a perspective view of a further preferred embodiment according to the present invention.

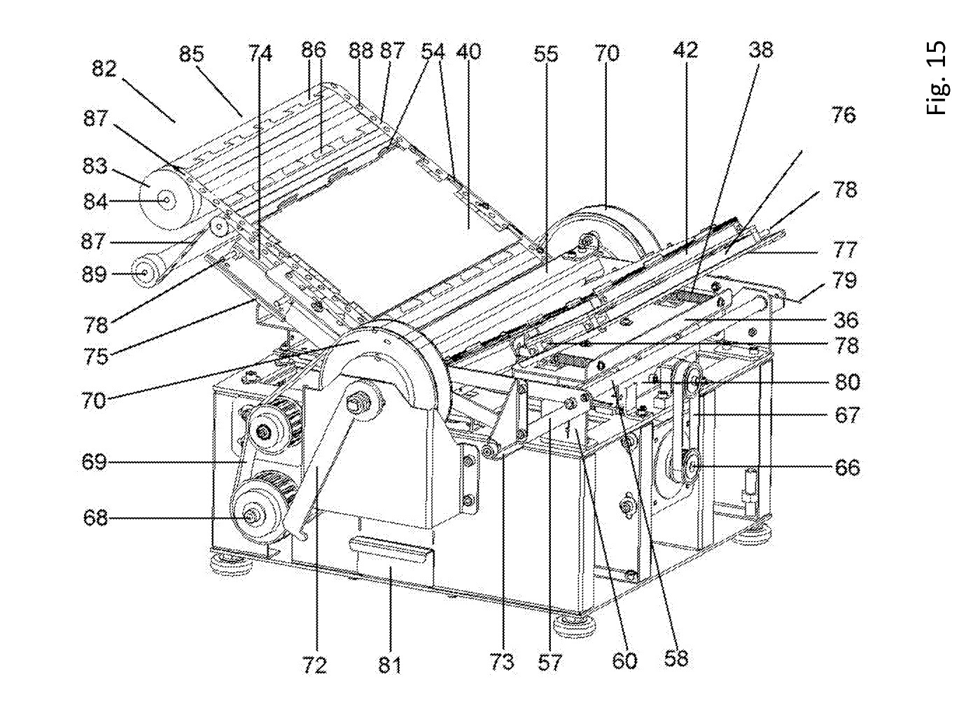

FIG. 15 is a perspective view of a further preferred embodiment.

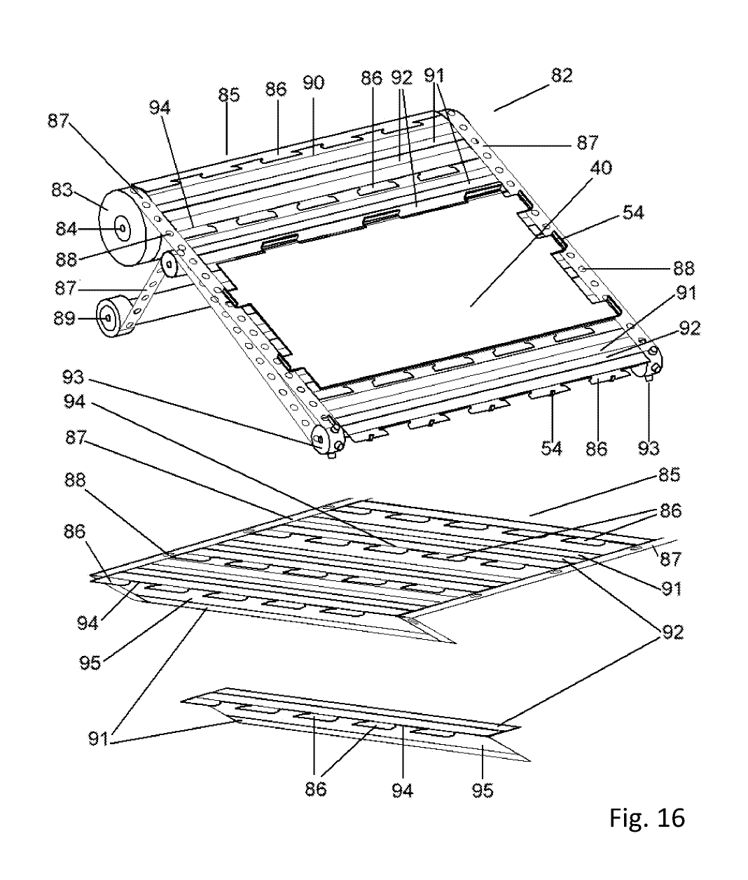

FIG. 16 is a schematic view of a further detail.

A first preferred embodiment (FIG. 6) according to the present invention relates to a book binding device 1. This concerns a punch device with punch blades, in this document also indicated as a cutting-out assembly. These punch blades can be designed as steel cylindrical ring segments, which are rigidly fastened to a rotating shaft, with a transverse section that is the same as the outline of the cut-outs in the material that is punched.

With an arrangement of the punch blades on a rotating shaft, an advantage is realised that such a punch device requires a small number of parts.

These punch blades can have a V-shaped underside as a cutting face. Both ends of the V-shaped underside of each punch blade protrude down and these ends are the first part to pierce into the sheets of paper or other material to be punched.

This punch device can punch sheets of paper as described in the patent application EP 1861263. Cut-outs and tabs are punched into these sheets to bind these sheets to each other into a book.

Three types of sheets are described in the aforementioned patent: A sheet that has a start cut-out and an end tab (EP 1861263 FIG. 6), a sheet that comprises a partial lip and a start and end lip (EP 1861263 FIG. 7) and a sheet that has a start cut-out and end cut-out (EP 1861263 FIG. 8). A punch device according to preferred embodiments according to the present invention can be arranged to produce one or more of these three variants of sheets.

The punch blades are fastened to a shaft that can be rotated by a lever such that the punch blades are pushed down, and they can be rotated back up after punching by a sprung construction (using one or more torsion springs around the shaft). During punching, the punch blades move through a steel cutting plate that supports the sheets of paper.

This cutting plate essentially has crenelated notches through which the punch blades move to cut out the cutouts and lips precisely.

The notches of the cutting plate are slightly larger than the transverse section of the punch blades such that a narrow cutting gap is left free between the punch blades and the cutting plate. Because the punch blades rotate around a shaft, a cylindrical ring is cut by each punch blade. Therefore the cut gap must leave adequate free space such that the punch blade does not collide against the cutting plate. However, too large a cutting gap reduces the punch quality.

The edges of the notches (=punch holes) of the cutting plate can instead of straight cross sections, have a cylindrical recess or a have conical recess that leaves more room on the non-cutting underside of the cutting plate.

By making the steel cutting plate thinner and having it rest on a holder that leaves more space for the punch blades, it is possible to prevent the punch blades colliding against the cutting plate.

The position of the cutting plate relative to the punch shaft is also important to properly guide the punch blades through the cutting holes. By preference the middle point of the punch shaft is positioned at the same height as the middle of the thickness of the cutting plate to optimally guide the punch blade through the cutting plate.

For better guiding of the punch blades through the cutting plate, the punch shaft can have a pawl that runs through a precisely fitting groove in the cutting plate (holder).

To reduce the necessary force on the shaft during the punch process, the ring-shaped punch blades can be mounted at different vertical positions on the shaft. For example in a V-shaped assembly. In this way, a maximum of two of three punch blades punch through the paper/material at a time.

By equipping the punch device with more than one cutting plate such that the stack of sheets to be punched is distributed into a number of thinner stacks on different cutting plates, multiple sheets can be punched at a time with one punch blade in one motion.

By designing the underside of the cylindrical ring segments as a V-shaped surface, at the start of the punching process the punch blade pierces better through the material to be punched and less force is needed for punching.

The material from the cut-outs in the paper at the edge of the paper is not supported by the cutting plate of the punch and lies free over the punch hole in this cutting plate.

To prevent the material from the cut-outs being folded into the punch hole during the last phase of the punching process and no longer being cut off, the middle part of the V-shaped underside of each punch blade must be sharp enough. This can be achieved by creating a recess in the middle part of the V-shaped underside (transverse section) of each punch blade. This V-section can have a radius in the middle part, (rounded top angle) for better milling of the recess.

Instead of steel cylindrical ring segments that are rigidly fastened to a rotating shaft, the punch blades can be designed as a thin strip with one or more V-shaped protrusions as a punch element. The ends of the V-shaped punch elements protrude down and these ends are the first part to pierce into the sheets of paper or other material to be punched. The steel strip is embedded in a plastic or light metal shaft and is guided through the material to be punched by the movement of this shaft. The movement is preferably a rotation of the shaft, but the shaft with the punch-blades strip can also make a linear movement perpendicular to the material to be punched through this material to punch the holes into it, as described in the patent application EP2802440, 19-11-2014.

Another preferred embodiment of the present invention relates to a punch device that first punches the sheet material and then automatically couples them to each other. This saves the user a lot of time. This automatic device preferably has a steel shaft with a number of cylindrical ring segments that are rigidly fastened to this rotating shaft and are distributed regularly over the length of this shaft, with a transverse section essentially equal to the outline of the cut-outs in the material that is punched. These ring segments have a V-shaped cutting face on both the underside and the top side. The ends of both V-shaped cutting faces of each ring segment-shaped punch element protrude both down and up and these ends are the first part to pierce the sheets of paper or other material to be punched. This invention also comprises multiple (preferably two) cutting plates, which are mounted on both sides of the punch shaft and positioned in a radial plane relative to this shaft.

Each cutting plate lies in one plane with a tilting paper tray (in the bottom position), such that the top surface of the cutting plate is positioned at the same height as the interior bottom of the paper tray. Each paper tray contains a stack of paper or other material. The punching process starts by rotating the shaft with punch elements one way first, such that the punch blades punch through the stack of paper in the first paper tray. The shaft with the punch elements then rotates in the opposite direction such that the opposite cutting face of the punch elements punches the stack of paper in the other paper tray. During this rotation of the punch shaft, once the punch blades come out of the punch holes in the first stack of sheets, there is the risk that these punch blades unintentionally pull these sheets out of the first paper tray.

This can be prevented by closing the top of this paper tray during punching using a protective cover that presses the sheets of paper or other material against the bottom of the paper tray. Another advantage of this protective cover is that it can cover the sharp punch blades to prevent the user coming into contact with the punch blades, avoiding the risk of injury.

Each end, or at least one end, of the shaft with punch elements has a cog such that each cog meshes with a separate gear rack on both the underside and the top side and the bottom gear racks and the top gear racks are each connected to their own respective push arm.

After the stacks of paper or other material in both stack holders have been punched, the punch shaft rotates further and both push arms are moved together in the direction of the punch shaft by the two pairs of gear racks. In this way, the push arms swing both stack holders up (the punch blades are then already positioned under the two stack holders) and both stack holders are oriented vertically or almost vertically in the top position and also shifted a certain distance the along the length of the punch shaft such that both stack holders are aligned relative to each other and both stacks of paper are positioned precisely opposite each other. The punch shaft rotates further such that the push arms slide further toward each other and sprung wedges on the push arms press both stack holders firmly together. This is the coupling phase of the device.

In this top position of both stack holders, elongated protrusions on both push arms push the lips of the punched sheets securely to each other and the two stacks of sheet material that are held in the stack holders are bound to each other. Finally, the punch shaft is rotated back a little bit and the push arms move back outward, causing the two stack holders to swing down and fall open under their own weight such that the bound book can be removed from the punching device.

In another preferred embodiment of the present invention, both stack holders can be moved some distance outward and thus be fixed in different positions, such that in each position of the stack holders, the sheets of material in the stack holders can be punched again, and by this repeated punching of the sheets of material, lips with higher flanges are formed to connect thicker stacks of material.

In another preferred embodiment, the punch shaft can be rotated into the different positions by an electric drive. Instead of two gear racks, the push arms can slide in a linear guide by means of an electric drive. The aforementioned repeated punching of sheets of material can also be driven electrically by having both stack holders slide outward using an electric drive (linear actuators/solenoids) and the entire punch and coupling process is controlled by control electronics and an electric drive of the various components. This electrically driven preferred embodiment can include a roller with spine covers in a cartridge. This applicator can automatically apply the spine covers to a book as described in European patent application EP2807030 FIG. 3/12. The spine covers are (temporarily) connected to each other with their exterior on the roll. The tabbed inner side (the coupling mechanism) of the spine cover lies flat on the paper tray aligned with the height of the punch blades. For lighter punching, the spine covers are provided with a tab strip that is coupled to the tabs to be punched of the sheets of paper to be bound. Instead of a tabbed inner side, a rectangular strip of material can also be used that is punched together with the sheets to be bound. The roll preferably comprises a middle section with spine covers and two side edges that include a long rolled-up out-feed strip that are rolled onto a counter spindle. In each binding cycle, a new spine cover is fed-in by turning the roll a fixed distance. This can preferably be done precisely by two sprockets that mesh with a row of perforations in both out-feed strips at the sides of the roll.

FIG. 1 shows a preferred embodiment of the punch mechanism that comprises a shaft 1 with a number of steel (or made of another hard material) cylindrical ring segments 2 on it, that are rigidly fastened to this shaft 1. This shaft 1 can be rotated by means of a handle 3. A cutting plate 4 has crenelated notches, through which the punch blades 2 move to precisely cut out the cut-outs and lips from sheets of paper or other material that lies on the cutting plate 4. The thin cutting plate 4 is supported by a robust thicker bottom plate 6 that comprises similar but slightly larger crenelated openings that are situated precisely under the crenelated openings of the cutting plate 4. The cutting plate 4 and bottom plate 6 are clamped at both ends into two corner pieces 5, which also have a shaft hole through which the punch shaft can rotate.

FIG. 2 shows a detail view of the punch blade 2 and the cutting plate 4. The punch blade 2 has a shaft hole 7 to which the shaft 1 can be fixed with a (shoulder) bolt. The cutting face of the punch blade 2 has a V-shaped surface that has a middle part 8 and protruding flanges 10, which pierce through the paper first.

The punch blade 2 comprises a concave opening 9 on at least one side, that is shaped either as a semi-circle, half-oval, quarter-circle or quarter oval or polygonal notch for punching the sidepieces of the lips in the paper. This punch blade 2 moves through a crenelated opening 11 of the cutting plate 4, which leaves a narrow cutting gap with the punch blade 2. The cutting plate 4 has several shaft holes 12, through which the cutting plate 4 can be screwed to the bottom plate with bolts.

FIG. 3 shows the punch shaft 1 with a number of steel (or made of another hard material) cylindrical ring segments 2 on it, that are rigidly fastened to this shaft 1. Each punch blade 2 has a shaft holes 7 to which the punch blade 2 can be fixed to the shaft 1 with a (shoulder) bolt. The punch shaft 1 comprises a guide channel 13 so that it can be positioned properly in the length direction in a corresponding protrusion of the cutting plate 4. For the embodiment shown in this figure, the punch shaft 1 has a square head 14 on both ends to fasten the handle 3 rigidly.

The punch blades 2 in this figure are mounted on the punch shaft 1 in different vertical positions to reduce the force needed during punching.

FIG. 4 shows an alternative preferred embodiment of the punch mechanism. The cutting elements of the punch are now formed by bent, sharp V-shaped protrusions 23 made of a thin strip 20 of hard material, for example hardened steel, such that the cutting elements comprise a transverse section that can punch similar cut-outs and lips from sheets of paper or other material. The protrusions 23 have two sidepieces 24 with sharp points that are fastened to a central triangular protrusion 22 of a long shared connecting strip 21, which accurately positions the different punch elements 23 and connects them to each other on the strip 20.

During punching, the V-shaped punch elements 23 move through the crenelated openings 11 of the cutting plate 4, which leaves a narrow cutting gap with the punch element 23. The thin strip 20 with the V-shaped punch elements 23 can be reinforced by embedding or casting it into a plastic or (light) metal holder 15, such that the V-shaped punch elements 23 fit precisely into the voids 16 of the holder 15 and thus to have extra support from the holder 15 during the punching process. The cutting plate 4 is supported by a bottom block 25 that comprises two end holders 26 with a shaft hole 27. The bottom block 25 comprises several supports 28, that can counteract flexing of the punch shaft 1 due to the high punching force and openings 29 through which the punched-out paper cuttings can be removed.

At both ends, the holder 15 comprises fastening pieces 17 for mounting the handle, a flange 19 around which a torsion spring can be slid, and a shaft part 18 that fits into the shaft hole 27 of the bottom block 26, such that the punch shaft 1 can rotate for punching.

FIG. 5 shows an alternative preferred embodiment of the punch mechanism from FIG. 4. Instead of a long punch shaft 1 and a holder 15 with plate-shaped punch blades and a long cutting plate 4, this variant has a cartridge for each punch element with a separate holder and a separate cutting plate. The cutting elements 23 of the punch are designed as bent, sharp V-shaped plates of hard material, for example hardened steel, such that the cutting elements 23 comprise a transverse section that can punch the same cut-outs and lips from sheets of paper or other material as the punch blades previously described.

The cutting elements 23 have two sidepieces 24 with sharp points that are fastened to a central triangular strip 22. This triangular strip has drilled holes 7 for fastening the cutting element 23 in the holder. The holder shown in this figure comprises a top side 15a that has drilled holes 7 corresponding with the cutting element 23. The top side 15a has a V-shaped underside to receive and support the cutting element 23.

The punch blade holder comprises a second part, the underside 15b. The plate-shaped cutting element 23 is now clamped securely between the top side 15a and bottom side 15b of the holder by bolts through the drilled holes 7. The holders of the different cutting elements 23 can be robustly connected to each other on a shaft by the connecting elements 15c. These connecting elements 15c, to side 15a and the underside 15b of the holder include a shaft hole 96 through which a steel shaft or threaded rod can be inserted.

Grooves and bulges on the connecting elements 15c and bulges and grooves fitting onto this on the underside 15b of the holders prevent the punch elements 23 twisting during punching. An alternative production method of the holders is casting or (insert) injection moulding of the V-shaped bent sharp plates of the cutting element 23 into one punch blade holder, which then comprises both the top side 15a and the underside 15b as one whole.

The cutting plate 4 is supported by a bottom block 25. The bottom block 25 comprises several supports 28 that can counteract flexing of the punch shaft 1 from FIG. 4 due to the high punching force and openings 29 through which the punched-out paper cuttings can be removed. The cutting plate 4 comprises an opening 11 through which the punch element 23 can move. The bottom blocks 25 can be mounted in series with their ends firmly together.

FIG. 6 shows a design of the present invention in which after punching, the sheets are also coupled to each other. This embodiment comprises a punch shaft with a cog 51 on the end of the shaft such that the cog 51 meshes with a gear rack 33 on the underside and meshes with a gear rack 34 on the top side, and the bottom gear rack 33 is connected to a push arm 35 and the top gear rack 34 is connected to the other push arm 36.

On the right-hand long side (in this figure) of the punch shaft, there is a tilting holder 39 (around the punch shaft) with a paper tray 40 mounted on it. On the left-hand long side (in this figure) of the punch shaft, there is a second tilting holder 41 (around the punch shaft) with a paper tray 42 mounted on it.

After punching, both push arms 35 and 36 move toward each other such that both holders 39 and 41 swing up with the respective stack holders 40 and 42 mounted on them. To do this, sprung wedges 37 (with a compression spring 38) on the push arm 36 push on the tilting holder 41. The tilting holder 41 slides a certain distance parallel to the punch shaft along guides in the grooves of guide blocks 43 after punching, but before coupling in the vertical position.

The tilting holder 39 slides parallel to the punch shaft a certain distance along guides in the grooves of guide blocks 44 after punching but before coupling in the vertical position, such that both stack holders 40 and 42 are positioned exactly opposite each other for the correct coupling of both stacks of paper.

The push arm 36 has elongated protrusions 45 that clamp the lips of the stack of punched sheets in the paper tray 42 through the cut-outs in the sheets of the stack in the paper tray 40 to bind the two stacks.

FIG. 7 shows a detail view of the punch mechanism of this embodiment.

A number of punch elements (blades) 31 are rigidly fixed to the punch shaft 30. The punch mechanism has two cutting plates 32 and 66 respectively, that are positioned on opposites sides of the punch shaft 30.

The cutting plate 32 rests on a bottom plate 69 that is fastened to the right-hand frame 70 of the punch mechanism. The second cutting plate 66 rests on a bottom plate 67 that is fastened to the left-hand frame 68 of the punch mechanism. The punch blades 31 move through crenelated openings 11 of the cutting plates 32 and 66.

FIG. 8 shows a detail view of the punch shaft with the punch blades of this embodiment.

A number of punch elements (blades) 31 are rigidly fastened to the punch shaft 30 with the characteristic that the punch elements 31 have a ring segment (cylinder segment) shape, of which the top side of each ring segment 31 comprises a cutting face with a V-shaped notch 47 and two sharp points 46 and the underside of each punch element 31 has a cutting face with a V-shaped notch 49 and two sharp points 48.

The punch blades 31 are fastened to the punch shaft 30 by means of shoulder bolts through the holes 50 in the punch blades 31.

FIG. 9 shows the punch shaft 30 with the punch blades 31, with cogs 51 at each end of the punch shaft 30 which drive the gear racks 33 and 34.

FIG. 10 shows the punch shaft 30 with the punch blades 31, with cogs 51 at each end of the punch shaft 30 which drive the gear racks 33 and 34.

The left-hand push arm 36 and the right-hand push arm 35 have elongated protrusions 45 that clamp the lips of the stacks of punched sheets in both paper trays into the cut-outs in the sheets of the opposite stack to bind the two stacks.

FIG. 11 shows a detail view of the hanger of the holder 39 with the paper tray 40 on the punch shaft 30 in this embodiment of the invention.

There is an arm 71 on the holder 39 with a rotating pin 52 that runs in the groove 53 of the guide block 44. The groove 53 runs upward at an angle in the guide block 44. When tilting up the holder 39 with the paper tray 40, the holder 39 is displaced by this angled guide over a fixed distance parallel to the punch shaft 30. The other holder is moved with a similar construction at the same time until both holders are aligned with each other so that their stack holders are positioned exactly opposite each other to couple both stacks of paper.

FIG. 12 shows the punching device with a protective cover 55 that presses the sheets of paper or other material against the bottom of the paper tray 42. The protective cover 55 is connected with arms 57 to a shaft 58 that can rotate in two holders 60 that are fixed to the frame of the punching device. The protective cover 55 has internal ribs 56. If the punch shaft rotates farther after punching of the first stack of sheets in the paper tray 42, the punch blades 31 are pulled out of the punch holes in this first stack of sheets. Having the ribs 56 press the sheets of paper or other material against the bottom of the paper tray 42 prevents the punch blades 31 unintentionally pulling these sheets out of this paper tray 42.

The left-hand push arm 36 has a number of sprung wedges 37 (with the compression spring 38) that, after punching, push on the tilting holder 41 and tilt this holder 41 up. The right-hand push arm 35 has a number of sprung wedges 37 (with the compression spring 38) that, after punching, push on the tilting holder 39 and tilt this holder 39 up. In the top vertical position of the two stack holders 40 and 42, the sprung wedges 37 firmly push these two stack holders together, such that both stacks of sheets can be coupled properly.

The top gear racks 34 are rigidly connected to the left-hand push arm 36. The bottom gear racks 33 are rigidly connected to the left-hand push arm 35. During punching of the stack of sheets in the paper tray 42, the protective cover 55 cannot rotate in the holders 60 and is therefore blocked because stop pins 59 rest on the top side of the push arm 36. After punching the stacks of paper in both stack holders, the protective cover 55 can again rotate freely in the holders 60. The protective cover 55 covers the sharp punch blades 31 to prevent the user coming into contact with the punch blades, avoiding the risk of injury.

FIG. 13 shows another embodiment of the present invention in which both stack holders can be moved outward some distance and thus be fixed in different positions such that the sheets of material in the stack holders can be punched again in each position of the stack holders, and by this repeated punching of the sheets of material, lips with higher flanges are formed in the sheets to couple thicker stacks of material.

The drawing, top-left in FIG. 13, shows the paper tray 40 in the original position. The sheets of paper can be positioned precisely in this paper tray 40 against supports 54.

The drawing, bottom-left in FIG. 13, shows the paper tray 40 with the supports 54 after this paper tray 40 has been moved up a certain distance. This movement of the paper tray 40 in the holder 39 (and the similar movement of the paper tray 42 in the holder 41) can be done by hand or with an electric drive in the holder 39.

The drawing, top-right in FIG. 13 shows a punched sheet of paper with a cut-out 61 between two lips as they are formed with a standard flange 62 by punching with the punch blade 31 once.

In the middle drawing, at right in FIG. 13, the sheet of paper 63 is moved up relative to the sheet of paper in the top right-hand drawing. The hatched line in this middle drawing shows the position of the punch blade 31.

In the bottom-right drawing in FIG. 13, the sheet of paper 64 is shown after the sheet of paper 63 has been punched with the punch blade 31 a second time and larger cut-outs are formed in this sheet of paper 64 with higher flanges 65.

FIG. 14 shows another preferred embodiment of an electrically driven punching-coupling device. Instead of a gear rack mechanism in which the punch shaft also drives the push arms, both the punch shaft with the pulleys 70 and the two push arms 36 are each driven separately by an electric motor. The punch shaft with the two pulleys 70 is driven by a belt 69 through a pulley 68 on the shaft of an electric motor.

The push arms 36 each slide in a linear guide 80 and are driven by a belt 67 and a pulley 66 driven by an electric motor. The paper tray 40 is fastened to an X-Y table 74 on the holder 75. The paper tray 40 can slide parallel in the punch shaft direction along a shaft 78, and for the repeated punching also over a certain distance are slid perpendicular on the punch shaft direction outward. These movements are performed by linear actuators/solenoids and directed by control electronics. The other paper tray 42 is fastened to a X-Y table 76 on the holder 77.

The paper tray 42 can slide parallel in the punch shaft direction along a shaft 78, and can also be slid outward a certain distance perpendicular to the punch shaft direction for the repeated punching.

The punching device has a protective cover 55 that presses the sheets of paper or other material against the bottom of the paper tray 42. This prevents the punch blades from unintentionally pulling these sheets back out of the paper tray 42 after punching the sheets in the paper tray 42 when the punch blades come up out of the paper tray 42 during the reverse rotation of the punch shaft. The protective cover 55 is connected with arms 57 to a shaft 58 that can rotate in two holders 60 that are fixed to the frame of the punching device.

The protective cover 55 is pressed by a spring 79 against this paper tray 42. The arms 57 of the protective cover 55 have a protruding hook 73. A pin 72 that is fastened to the rotating pulley 70 of the punch shaft can tilt up against this protruding hook 73 and rotate the protective cover 55 up after punching. Both stack holders 40 and 42 then lie free for the coupling process to be folded against each other by the push arms 36 into a vertical position.

The waste cuttings resulting from punching are received in a waste paper tray 81, which can be emptied.

FIG. 15 shows a similar electrically powered punching-coupling device as in the previous figure, which now comprises an applicator to automatically apply cover strips to the spine of a book. The applicator is designed as an exchangeable cartridge 82 that comprises a roll 83 with a strip 85 of spine covers that are temporarily linked to each other by perforation/tear edges.

Each spine cover contains a tabbed connection strip with a number of lips 86. If desired, the spine covers can contain a non-tabbed rectangular coupling strip in which the lips are punched by the punch mechanism during the punching process. The strip 85 has guide strips 87 on each side.

By preference, the guide strips 87 have perforation holes 88. The cartridge 82 comprises on its top side an integrated paper tray 40 with supports 54 which precisely position the sheets of paper in this paper tray 40 for punching and coupling.

The cartridge 82 comprises a shaft 89 with two counter spindles around which the guide strips 87 are wound. Before a new punching-coupling cycle is started, the roll 83 of spine covers is rotated further about its axis 84, such that a new spine cover is again placed with its lips 86 in exactly the correct position.

The top drawing of FIG. 16 shows the exchangeable cartridge 82. The cartridge 82 comprises two sprockets 93 that mesh with the perforation holes 88 of both guide strips 87 and always rotate the roll by the correct angle to supply a new spine cover. The middle drawing of FIG. 16 shows the strip 85 of spine covers temporarily linked to each other.

Each spine cover has a tabbed coupling strip with a number of lips 86, which is fastened to a rectangular strip 95. The rectangular strip 95 contains a crease 94 along its whole middle axis and runs under the tabbed coupling strip with the lips 86. The rectangular strip 95 has an adhesive edge or strip of double-sided tape 91 on its front side.

The bottom drawing of FIG. 16 shows a spine cover. The rectangular strip 95 has a second adhesive edge or strip of double-sided tape 92 on its back side. The rectangular strip 95 is folded double at the central crease 94 and in this position is ready to be processed in the punching-coupling process. After coupling, the front side of the rectangular strip 95 is folded as a flap around the spine of the book and glued in place on the front cover of the book by means of the adhesive edge or strip of double-sided tape 91.

The back side of the rectangular strip 95 is glued to the back cover by means of the adhesive edge or strip of double-sided tape 92.

Binding device according to a further embodiment with the characteristic that it comprises at least two cutting plates with a row of crenelated notches, such that a stack of sheets of paper can lie on each cutting plate, through which the punch blades successively move to precisely cut out the cut-outs and lips and the punching device comprises paper trays on two edges of the long side of the punch shaft that can each tilt around the punch shaft, of which in the lowest position the bottoms are aligned with the corresponding cutting plates such that the two cutting plates fall into an opening of the stack holders and the punching device comprises two push arms with elongated protrusions which can tilt both stack holders up such that in the top position, these stack holders are oriented vertically or almost vertically and that when tilting the two stack holders up, these stack holders are also shifted over a certain distance parallel to the length direction of the punch shaft, such that both stack holders are aligned relative to each other and sprung wedges on the push arms press the stack holders against each other in the top coupling position and the protrusions on the push arms can then push the lips of both punched stacks of sheets to interlock with each other.

Binding device according to a further embodiment with the characteristic that the cutting face comprises a rectangular transverse profile of which at least one short side (perpendicular to the punch shaft) of this transverse profile comprises a concave recess that is shaped as either a half circle, half oval, quarter circle or quarter oval or polygonal notch for punching the sidepiece(s) of a lip, and the cut out is limited to the middle part of a short side of the transverse profile and thus leaves a certain distance free at the ends of the short side of the transverse profile, such that the long side of the rectangular transverse profile, which lies opposite the long side and adjoins the shaft, comprises a flange or two flanges.

Binding device according to a further embodiment with the characteristic that the cutting face of a punch element comprises a rectangular transverse profile of which both short sides (perpendicular to the punch shaft) of this transverse profile contain a concave recess that is shaped as either a half circle, half oval, quarter circle or quarter oval or polygonal notch for punching the sidepieces of the lips, and the cut-out is limited to the middle part of each short side of the transverse profile and thus leaves a certain distance free at the ends of each short side of the transverse profile, such that the long side of the rectangular transverse profile, which lies opposite the long side and adjoins the shaft, comprises two flanges.

Binding system according to a further embodiment with the characteristic that the underside of each ring segment is the cutting face of the respective punch element, that comprises a transverse profile, such that the (cutting) edges of all the punch blades punch a regular row of cut-outs along the binding side of sheets of paper, such that between two adjoining cut-outs one lip (tab) is always left free, which can be clamped in place between a similar cut-out of one or more other sheets.

Binding system according to a further embodiment with the characteristic that the cutting face of a punch comprises a concave V-shaped face on the underside of the ring segment, which is perpendicular to the outer perimeter of the ring segment or makes a sharp angle with this outer perimeter, such that both ends at the sides on the underside of the ring segment-shaped punch element by the V-shaped cutting edge of the punch blade protrude as a number of sharp points.

Binding device according to a further embodiment with the characteristic that at the concave V-shaped surface of the cutting face of the punch, the middle of the V-shape is rounded with a radius (has a rounded top corner) for easy milling of the recess and the middle part of the V-shaped cutting face is recessed relative to the cutting edges of the cutting face on both long sides of the rectangular transverse profile for better cutting functioning of these straight edges in the last phase of the punching process.

Binding device according to a further embodiment in which the cutting elements of the punch are formed by bent, sharp V-shaped protrusions made of a thin strip of hard material, for example hardened steel, such that the cutting elements comprise a transverse section.

Binding device according to a further embodiment with the characteristic that the strip of hard material is cast into a plastic or light metal shaft, where this shaft is rotated during punching and therefore the cutting elements pierce through the material to be punched.

Binding device according to a further embodiment for punching out a cut-out between two adjoining lips of a sheet for use in a binding system that has a shaft, at which a number of punch elements (blades) are rigidly fastened with the characteristic that the punch elements have the form of a ring segment (cylinder segment) of which both the underside and the top side of each ring segment have a cutting face.

Binding device according to a further embodiment with the characteristic that the punch blades on the shaft successively punch the sheets of material on both stack holders in the bottom position of the two stack holders, and in the top position of both stack holders, elongated protrusions on both push arms couple the lips of the punched sheets to each other to bind the two stacks of sheet material that are held in the stack holders.

Binding device according to a further embodiment with the characteristic that both stack holders can be moved some distance outward and thus be fixed in different positions, such that in each position of the stack holders, the sheets of material in the stack holders can be punched again by the punch mechanism, and by this repeated punching of the sheets of material lips with higher flanges are formed to couple thicker stacks of material.

Binding device according to a further embodiment with the characteristic that the punch shaft and/or the push arms and/or the stack holders that slide outward can be rotated or shifted into the different positions by one or more electric drives that can be controlled by a programmable electronic controller.

Binding device according to a further embodiment with the characteristic that it comprises an applicator for the automatic application of a cover around the spine of a book, which is designed as a cartridge with a roll of covers temporarily linked to each other by means of perforation or tear lines, and positions a new cover for each punch and coupling cycle by means of an electric drive under the stack of sheets to be bound from the paper tray.

The present invention is described in the preceding on the basis of several preferred embodiments. Different aspects of different variants are considered to be described in combination with each other such that all combinations that upon reading by a skilled person in the field on the basis of this document can be regarded as being read within the concept of the invention. The preferred embodiments do not limit the extent of protection of this document. The requested rights are laid down in the appended claims.

1. Book binding device to perform a binding process comprising a coupling process in which two stacks of sheets, such as sheets of paper, each with at least one sheet, are connected to each other by tabs in the sheets and a cutting process to produce the tabs along a respective tab edge of at least one of the two stacks to be coupled, to bind the sheets into a book along a spine side of the sheets, the device comprising:
two stack holders to each hold a stack of at least one sheet,
a cutting assembly to perform the process of cutting out sheet material to form the tabs,
a coupling assembly to couple the tabs of two respective stacks to produce the book, in which
the stack holders serve as positioners for the two stacks to keep holding the stacks properly oriented during the binding process.

2. Book binding device according to conclusion 1 in which the cutting assembly comprises a shaft to which a number of cutting elements are attachable with an outline shape that is suitable for cutting during a rotational movement of the shaft, such as with a shape of a ring segment or cylinder segment.

4. Book binding device according to conclusion 1 or 2 comprising drive means such as a motor or crank to drive the cutting-out assembly.

5. Book binding device according to conclusion 4 in which the drive means are connected to the coupling assembly, such as by a transmission, such as by a gear rack construction, by further preference with a cog arranged on the shaft of the cutting assembly.

6. Book binding device according to one or more of the preceding claims in which at least one of the stack holders in the book binding device is arranged to be moved along the tab edge of the stack to transfer the respective stack between a cutting-out position and a coupling position, by preference along a movement stroke of essentially a half tab length or essentially a whole tab length.

7. Book binding device according to one or more of the preceding claims in which at least one, and preferably each, end of the punch shaft has a cog such that each cog meshes with a separate gear rack on both the underside and the top side, and the bottom gear racks and the top gear racks are each connected to their own respective push arm.

8. Book binding device according to one or more of the preceding claims in which the punch blades in the book binding device are clamped to the shaft in a number of different vertical positions to punch in steps to reduce the force during punching.

9. Book binding device according to one or more of the preceding claims in which cutting elements of the punch are formed by bent, sharp V-shaped protrusions made of a thin strip of hard material, for example hardened steel, such that the cutting elements comprise a transverse section.

10. Punching device according conclusion 9 where the strip of hard material is cast into a plastic or light metal shaft, where this shaft is rotated during punching and therefore the cutting elements pierce through the material to be punched.

11. Punching device according to conclusion 9 in which the punch mechanism comprises a number of cartridges linked in series, which each comprise a separate cutting element embedded in a plastic or metal shaft section and the cutting plate corresponding with this embedded into a plastic or metal holder, such that the holders of the cutting plates can be coupled to each other robustly and the shaft sections of the cutting elements can be fastened to each other robustly into a shared punch shaft, preferably by means of mortise and tenon-type joints between the shaft sections to prevent twisting of the punch shaft.

12. Book binding device according to one of more of the preceding claims in which the punch blades on the shaft successively punch the sheets of material on both stack holders in the bottom position of the two stack holders, and in the top position of both stack holders, elongated protrusions on both push arms couple the lips of the punched sheets to each other to bind the two stacks of sheet material that are held in the stack holders.

13. Book binding device according to one of more of the preceding claims in which both stack holders can be moved some distance outward and thus be fixed in different positions, such that in each position of the stack holders, the sheets of material in the stack holders can be punched again by the punch mechanism and by this repeated punching of the sheets of material, lips with higher flanges are formed to couple thicker stacks of material.

14. Book binding device according to one of more of the preceding claims in which the punch shaft and/or the push arms and/or the stack holders that slide outward can be rotated or shifted into the different positions by one or more electric drives that can be controlled by a programmable electronic controller.

15. Book binding device according to one of more of the preceding claims in which it comprises an applicator for the automatic application of a cover around the spine of a book, which is designed as a cartridge with a roll of covers temporarily linked to each other by means of perforation or tear lines, and for each punch and coupling cycle positions a new cover under the stack of sheets to be bound from the paper tray by means of an electric drive.

16. Applicator for the automatic application of a cover around the spine of a book, with the characteristic that it comprises a cartridge with a roll of covers temporarily connected to each other by means of perforation or tear lines, where each cover has a rectangular exterior, such that one or more creases are applied parallel to the long side of the rectangular exterior, and both long edges of the rectangular exterior include a glue strip or double-sided tape, with a coupling strip in between, optionally tabbed, that is fastened to the middle part of the rectangle such that upon folding the rectangular exterior of the cover double at a crease under the connection strip, the part of the coupling strip with the tabs in it, or out of which the tabs are to be punched by the punch device, protrude freely.

17. Applicator for the automatic application of a cover around the spine of a book according to conclusion 17, with the characteristic that the roll, on both sides of the middle strip of covers coupled to each other, has two guide strips or bands, with optional sprocket perforation holes, such that the guide strips or bands are wound around a counter spindle for more accurate feed of the covers.
